(19) United States
(12) Patent Application Publication
(10) Pub. No.: US 2016/0144385 A1
(43) Pub. Date: May 26, 2016

(54) Painting Kit

(71) Applicant: Marcos Espaillat, Edison, NJ (US)

(72) Inventor: Marcos Espaillat, Edison, NJ (US)

(21) Appl. No.: 14/549,199

(22) Filed: Nov. 20, 2014

(51) Int. Cl. B05B 11/00; B60B 3/00; B05B 15/04; B60B 7/00

(52) U.S. Cl. CPC B05B 11/0005; B60B 7/00; B60B 3/00; B05B 15/045

(57) ABSTRACT

A wheel painting kit for painting a wheel while the wheel is coupled to a vehicle includes the wheel that may be coupled to the vehicle. A tire is coupled to the wheel. A cover is structured to be coupled to the tire so the wheel is exposed. A first container is provided. The first container contains a primer. The first container selectively releases the primer onto the wheel after the cover is positioned on the tire. The primer is applied only to the wheel. The wheel and the tire remain on the vehicle while the primer is applied to the wheel. A second container is provided. The second container contains a paint. The second container selectively releases the paint onto the wheel after the primer is applied to the wheel.

### BACKGROUND OF THE DISCLOSURE

### Field of the Disclosure

The disclosure relates to painting kits and more particularly pertains to a new painting kit for painting a wheel while the wheel is coupled to a vehicle.

### SUMMARY OF THE DISCLOSURE

An embodiment of the disclosure meets the needs presented above by generally comprising a wheel that may be coupled to a vehicle. A tire is coupled to the wheel. A cover is structured to be coupled to the tire so the wheel is exposed. A first container is provided. The first container contains a primer. The first container selectively releases the primer onto the wheel after the cover is positioned on the tire. The primer is applied only to the wheel. The wheel and the tire remain on the vehicle while the primer is applied to the wheel. A second container is provided. The second container contains a paint. The second container selectively releases the paint onto the wheel after the primer is applied to the wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a painting kit according to an embodiment of the disclosure.

FIG. 2 is a back view of an embodiment of the disclosure.

FIG. 3 is a front perspective view of an embodiment of the disclosure.

FIG. 4 is an in-use view of an embodiment of the disclosure.

FIG. 5 is a perspective view of an alternative embodiment of the disclosure.

### DESCRIPTION OF THE PREFERRED EMBODIMENT

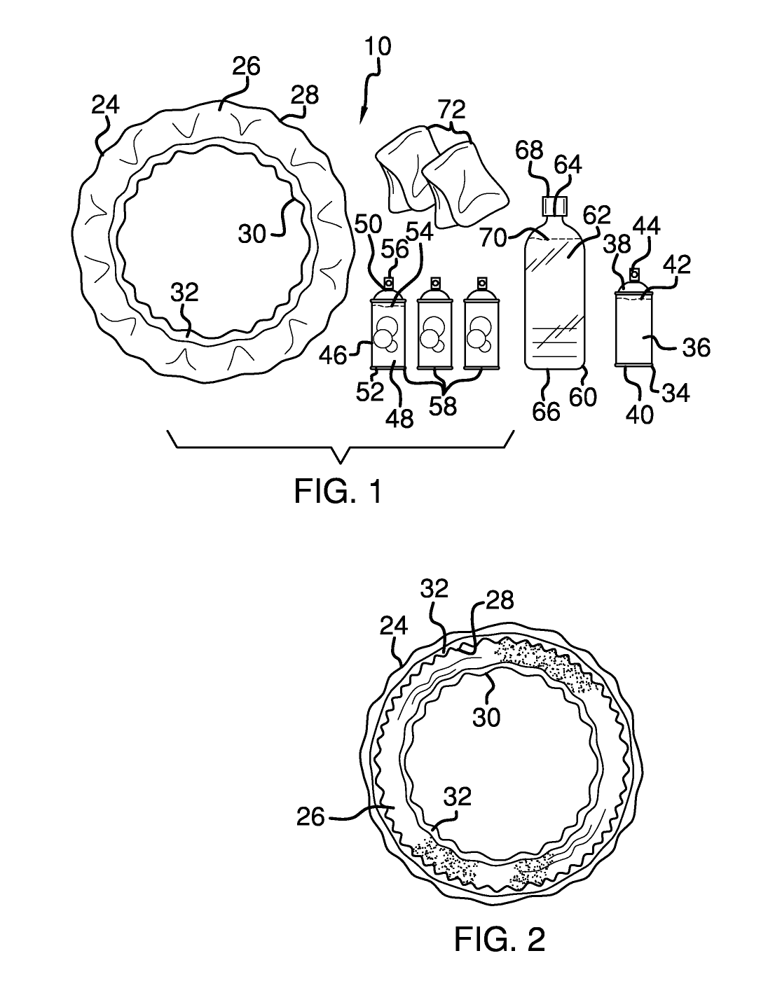

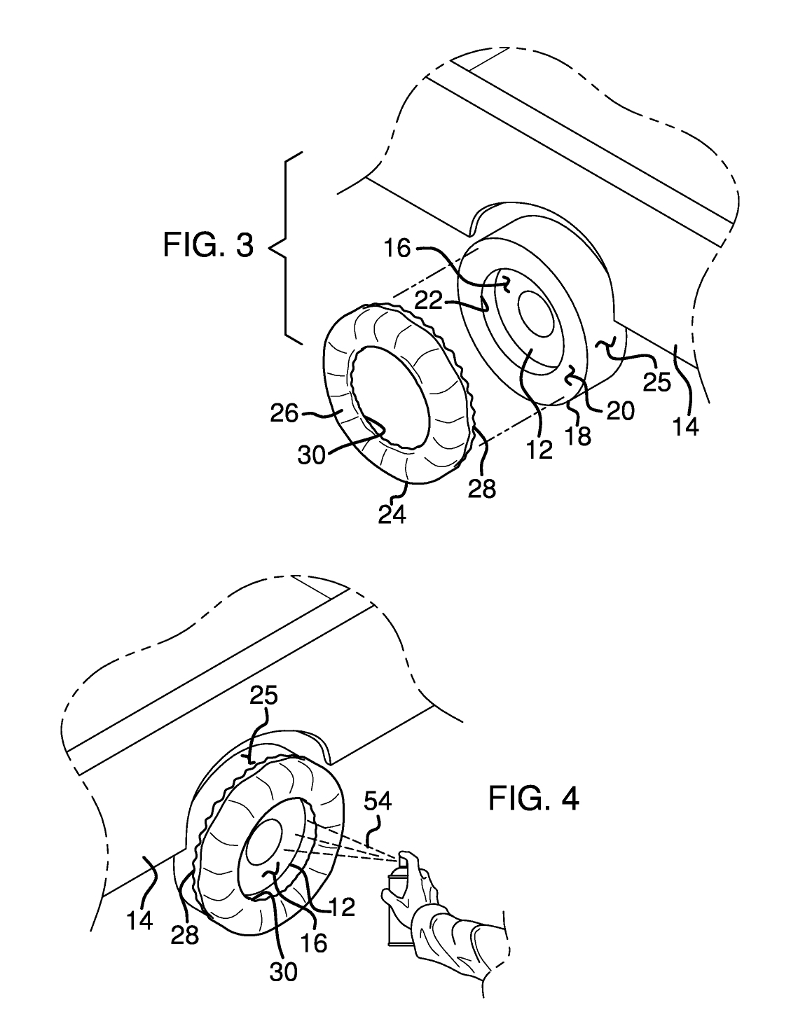

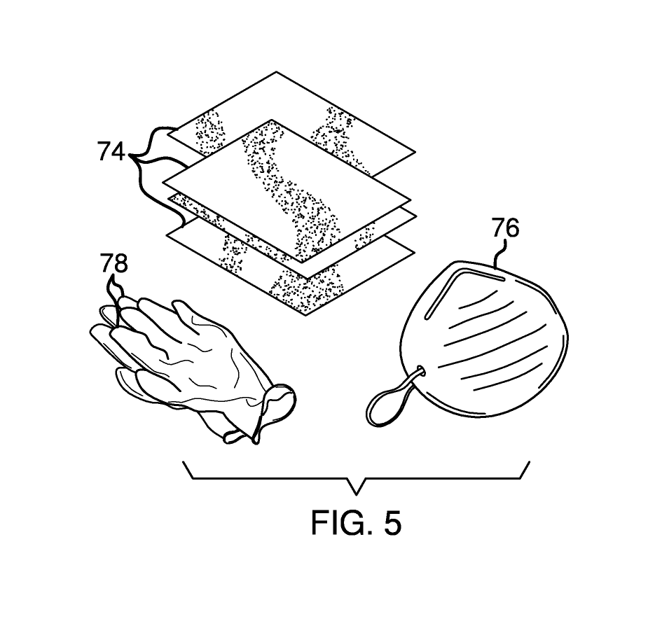

With reference now to the drawings, and in particular to FIGS. 1 through 5 thereof, a new painting kit embodying the principles and concepts of an embodiment of the disclosure and generally designated by the reference numeral 10 will be described.

As best illustrated in FIGS. 1 through 5, the wheel painting kit 10 generally comprises a wheel 12 that may be coupled to a vehicle 14. The vehicle 14 may be a passenger vehicle of any conventional design. The wheel 12 is structured to have a front surface 16 that is exposed when the wheel 12 is coupled to the vehicle 14. The wheel 12 may be a vehicle wheel of any conventional design.

A tire 18 is provided. The tire 18 is structured to have a frontmost surface 20 extending between an innermost edge 22 and an outermost surface 25 of the tire 18. The innermost edge 22 of the tire 18 is coupled to the wheel 12 so the frontmost surface 20 of the tire 18 is positioned adjacent to the front surface 16 of the wheel 12. The tire 18 may be a vehicle tire of any conventional design.

A cover 24 is provided. The cover 24 has a primary wall 26 extending between each of an outer edge 28 and an inner edge 30 of the cover 24. Each of the outer 28 and inner 30 edges of the cover 24 is curvilinear with each other so the cover 24 forms a closed ring. The primary wall 26 of the cover 24 is curved so the outer edge 28 of the cover 24 is directed rearwardly from the primary wall 26 of the cover 24. A pair of elastic bands 32 is each coupled to and is coextensive with an associated one of the outer 28 and inner 30 edges of the cover 24. The cover 24 may be comprised of a fluid impermeable and deformable material.

The cover 24 is removably positioned on the tire 18. The outer edge 28 of the cover 24 engages the outermost surface 25 of the tire 18 and the inner edge 30 of the cover 24 engages the innermost edge 22 of the tire 18. The pair of elastic bands 32 retains the cover 24 on the tire 18. Moreover, the primary wall 26 of the cover 24 completely covers the frontmost surface 20 of the tire 18 leaving the front surface 16 of the wheel 12 exposed.

A first container 34 is provided. The first container 34 has an extraneous wall 36 extending between each of a top end 38 and a bottom end 40 of the first container 34. The first container 34 contains a primer 42. The first container 34 may be an aerosol container of any conventional design. Additionally, the primer 42 may be a fluid primer of any conventional design.

A first nozzle 44 is coupled to the top end 38 of the first container 34. The first nozzle 44 is selectively engaged to release the primer 42 from the first container 34. Additionally, the first nozzle 44 selectively releases the primer 42 onto the front surface 16 of the wheel 12 after the cover 24 is positioned on the tire 18. The primer 42 is applied only to the front surface 16 of the wheel 12. The wheel 12 and the tire 18 remain on the vehicle 14 while the primer 42 is applied to the wheel 12.

A second container 46 is provided. The second container 46 has an exposed wall 48 extending between each of an upper end 50 and a lower end 52 of the second container 46. The second container 46 contains a paint 54. The second container 46 may be an aerosol container of any conventional design. Additionally, the paint 54 may be an automotive paint of any conventional design.

A second nozzle 56 is coupled to the upper end 50 of the second container 46. The second nozzle 56 is selectively engaged to release the paint 54 from the second container 46. Moreover, the second nozzle 56 selectively releases the paint 54 onto the front surface 16 of the wheel 12 after the primer 42 is applied to the front surface 16 of the wheel 12. The second container 46 may be one of a plurality of second containers 58. Each of the second containers 58 may contain a different color of the paint 54.

A third container 60 is provided. The third container 60 has an outermost wall 62 extending between a topmost end 64 and a bottommost end 66 of the third container 60.

The topmost end 64 of the third container 60 is open. A cap 68 is removably coupled to the topmost end 64 of the third container 60. The third container 60 contains a liquid cleaner 70.

A pair of cloths 72 is provided. The liquid cleaner 70 is selectively applied to the cloths 72. The cloths 72 are used to clean the front surface 16 of the wheel 12 prior to the primer 42 being applied to the front surface 16 of the wheel 12. Additionally, the liquid cleaner 70 prepares the front surface 16 of the wheel 12 to receive the primer 42.

Alternatively, a plurality of sheets of sandpaper 74 is provided. The sheets of sandpaper 74 are used to abrade the front surface 16 of the wheel 12 prior to the application of the primer 42 and the paint 54. A mask 76 is provided. The mask 76 may be worn to prevent inhalation of the paint 54 and the primer 42. A pair of gloves 78 is provided. The pair of gloves 78 may be worn to prevent physical contact with the primer 42 and the paint 54.

In use, the kit 10 is utilized to paint the wheel 12 while the wheel 12 remains on the vehicle 14. The cover 24 is removed from the tire 18 after the wheel 12 has been painted. The cover 24 prevents the tire 18 from being painted. Additionally, the kit 10 may be used multiple times to paint the wheel 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheel painting kit comprising:
a wheel configured to be coupled to a vehicle;
a tire coupled to said wheel;
a cover structured to be coupled to said tire such that said wheel is exposed;
a first container, said first container containing a primer, said first container selectively releasing said primer onto said wheel after said cover is positioned on said tire such that said primer is applied only to said wheel, said wheel and said tire remaining on the vehicle while said primer is applied to said wheel; and
a second container, said second container containing a paint, said second container selectively releasing said paint onto said wheel after said primer is applied to said wheel.

2. The kit according to claim 1, further comprising said wheel being structured to have a front surface being exposed when said wheel is coupled to the vehicle.

3. The kit according to claim 2, further comprising said tire being structured to have a frontmost surface extending between an innermost edge and an outermost surface of said tire, said innermost edge of said tire being coupled to said wheel such that said frontmost surface of said tire is positioned adjacent to said front surface of said wheel.

4. The kit according to claim 1, further comprising said cover having a primary wall extending between each of an outer edge and an inner edge of said cover.

5. The kit according to claim 4, further comprising each of said outer and inner edges of said cover being curvilinear with each other such that said cover forms a closed ring.

6. The kit according to claim 5, further comprising:
said wheel having a front surface;
said tire having an outermost surface, an innermost edge and a frontmost surface; and
said cover being removably positioned on said tire such that said outer edge of said cover engages said outermost surface of said tire and said inner edge of said cover engages said innermost edge of said tire wherein said primary wall of said cover completely covers said frontmost surface of said tire leaving said front surface of said wheel being exposed.

7. The kit according to claim 1, further comprising said first container having an extraneous wall extending between each of a top end and a bottom end of said first container.

8. The kit according to claim 7, further comprising a first nozzle coupled to said top end of said first container, said first nozzle being selectively engaged such that said first nozzle releases said primer from said first container.

9. The kit according to claim 1, further comprising said second container having an exposed wall extending between each of an upper end and a lower end of said second container.

10. The kit according to claim 9, further comprising a second nozzle coupled to said upper end of said second container, said second nozzle being selectively engaged such that said second nozzle releases said paint from said second container.

11. A wheel painting kit comprising:
a wheel configured to be coupled to a vehicle, said wheel being structured to have a front surface of said wheel being exposed when said wheel is coupled to the vehicle;
a tire structured to have a frontmost surface extending between an innermost edge and an outermost surface of said tire, said inner edge of said tire being coupled to said wheel such that said frontmost surface of said tire is positioned adjacent to said front surface of said wheel;
a cover, said cover having a primary wall extending between each of an outer edge and an inner edge of said cover, each of said outer and inner edges of said cover being curvilinear with each other such that said cover forms a closed ring;
said cover being removably positioned on said tire such that said outer edge of said cover engages said outermost surface of said tire and said inner edge of said cover engages said innermost edge of said tire wherein said primary wall of said cover completely covers said frontmost surface of said tire leaving said front surface of said wheel being exposed;
a first container, said first container having an extraneous wall extending between each of a top end and a bottom end of said first container, said first container containing a primer;
a first nozzle coupled to said top end of said first container, said first nozzle being selectively engaged such that said first nozzle releases said primer from said first container;
said first nozzle selectively releasing said primer onto said wheel after said cover is positioned on said tire such that said primer is applied only to said wheel, said wheel and said tire remaining on the vehicle while said primer is applied to said wheel;
a second container, said second container having an exposed wall extending between each of an upper end and a lower end of said second container, said second container containing a paint;
a second nozzle coupled to said upper end of said second container, said second nozzle being selectively engaged such that said second nozzle releases said paint from said second container; and
said second nozzle selectively releasing said paint onto said wheel after said primer is applied to said wheel.
